(19) United States
(12) Patent Application Publication
(10) Pub. No.: US 2019/0170123 A1
(43) Pub. Date: Jun. 6, 2019

(54) RECORDING OF MEASURED VALUES FOR A WIND TURBINE

(71) Applicant: Wobben Properties GmbH, Aurich (DE)

(72) Inventors: René MERTENS, Oranienburg (DE); Albrecht BRENNER, Aurich (DE); Frank KNOOP, Aurich (DE); Uwe HELMKE, Aurich (DE)

(21) Appl. No.: 16/320,829

(22) PCT Filed: Jul. 11, 2017
(86) PCT No.: PCT/EP2017/067317

§ 371 Date: Jan. 25, 2019

(30) Foreign Application Priority Data
Jul. 29, 2016 (DE) 10 2016 114 051.1

(51) Int. Cl. F03D 17/00; G01W 1/08

(52) U.S. Cl. CPC F03D 17/00; G01W 1/08; B64C 2201/125; F05B 2270/80; F05B 2270/321; F05B 2270/322; F05B 2270/32

(57) ABSTRACT

A method for recording at least one measured value, wherein the measured value is recorded by means of at least one measuring drone, and the measuring drone flies into a predefinable position to record the measured value, is held in the predefinable position by a position adjustment or its change in relation to the predefinable position is recorded, records the at least one measured value, and transmits the at least one recorded measured value or at least one value representing said recorded measured value to an evaluation device and/or stores said recorded measured value.

### BACKGROUND

### Technical Field

The present invention relates to a method for recording at least one measured value, in particular for use in controlling a wind power installation. The present invention furthermore relates to a method for operating at least one wind power installation on the basis of at least one recorded measured value. The present invention furthermore relates to a measuring drone and an arrangement of a plurality of measuring drones. The present invention furthermore relates to a wind power installation and a wind power system with one or more wind power installations.

### Description of the Related Art

Wind power installations are generally known and are used to generate electrical energy from wind. In order to control them, it can be at least helpful to record characteristics of the wind. This includes, in particular, wind speed and wind direction, which will also be referred to below as wind value or wind values. It is furthermore helpful to have knowledge of the sound emissions radiated by the wind power installation, in particular during ongoing operation, if necessary in order to reduce noise pollution from wind power installations, for example by adjusting the operating point.

Measurements can also be carried out, for example, to determine power curves, said measurements normally being carried out using a meteorological mast arranged upstream of the wind power installation.

However, a meteorological mast is anchored in a fixed position, as a result of which the measurements may be correct for a single wind direction only and need to be corrected if the wind directions deviate therefrom. The installation of the meteorological mast is also complex due to the necessary anchorage and stay wires. In the case of sound measurements, only the sound radiation in one direction can be detected with the measured value, so that a two-dimensional or three-dimensional measurement to determine a sound field is impossible.

Alternatively, measurements could also be carried out, in particular, to determine wind values, with measuring apparatuses on the wind power installation concerned. However, the use of a nacelle anemometer, in particular, is very inexact, also due to the fact that the operation of the wind power installation interferes with this measuring device, i.e., particularly the rotation of the rotor, wherein the rotor blades pass over the measuring apparatus.

Furthermore, the use of measuring devices on the nacelle of a wind power installation regularly causes the problem that said measuring devices can determine the wind speed in the area of the nacelle only, but not in the entire area of the rotor surface, i.e., in the area over which the rotor blades pass during the operation of the wind power installation. The recording of a wind field is thus normally impossible or only inadequately possible.

Technically complex measurements such as an ultrasonic measurement may be considered, but are highly complex and expensive.

### BRIEF SUMMARY

Provided is a wind field or a sound field for a wind power installation that can be recorded in a simple manner from different directions. A method is proposed according to the invention. The method is provided to record at least one measured value. A measured value of this type may be a wind value, such as a wind speed, a wind direction, a gustiness of the wind or a measured sound value, such as a sound pressure level or frequencies of the sound. It is proposed to use a measuring drone for the recording. For the sake of simplicity, the measuring drone can also be referred to as a drone.

This measuring drone, wherein a plurality of measuring drones can also be used, flies into a predefinable position to record the wind value or a plurality of wind values. This predefinable position may, for example, be level with the nacelle of a wind power installation, wherein a predefined distance, such as, for example, 100 meters, is maintained. This position in front of the wind power installation can mean, in particular, that this position is immediately upwind of the wind power installation, i.e., the wind power installation is located immediately behind this measuring drone in relation to the wind direction prevailing at that time. However, other positions may also be considered, particularly if a wind field or a sound field is to be measured and also particularly if a plurality of measuring drones operating simultaneously in different positions are used.

The measuring drone now considered is now held in this predefinable position by a position adjustment. As a result, the measured values can be recorded at this position. Furthermore or alternatively, a change in the position of the measuring drone in relation to the predefinable position can also be recorded. As a result, this change in the position of this measuring drone can be taken into account in the evaluation and can be subtracted if necessary in order to determine a measured wind value. This may relate to wanted or unwanted changes in the position of the measuring drone. It can also be provided, for example, that the position forms a position path to be flown along.

The at least one measured value is now recorded by the measuring drone and transmitted to an evaluation device. To do this, the wind value, i.e., for example, the wind speed and/or the wind direction, or the measured sound value, i.e., for example, the sound pressure level, i.e., the sound volume, or frequencies of the sound can already be calculated in the measuring drone from the recorded values, i.e., from raw data, and can be transmitted. It is also conceivable here for the raw data to be transmitted and the corresponding wind values or measured sound values subsequently calculated therefrom in the evaluation device. An intermediate solution is also conceivable in which an initial pre-evaluation is carried out on the measuring drone, or only some of the wind values or measured sound values are calculated, or a calculation without normalization is performed, to name but a few examples. In particular, a gustiness, for example, can also be determined subsequently in the evaluation device from a plurality of wind speed values. Alternatively or in addition to the transmission, it is also provided to store the measured values in a memory of the drone in order to evaluate them only after the drone has landed.

The measuring drones can also be used to determine wind conditions at planned sites in order to determine the suitability of the site, which can also be referred to as a site assessment. Characteristics of the site, such as revenue forecasts, height profiles, wind shear and turbulence intensity, can be determined.

One embodiment of the invention proposes an autonomous replacement of one measuring drone with another measuring drone as soon as the battery of the first measuring drone is spent. Measuring phases of any given length can be performed by means of a cyclical alternation of this type, despite limited flight times of a measuring drone.

According to one embodiment, it is proposed that the measuring drone is held in the predefinable position by means of a position adjustment. Furthermore or alternatively, it is proposed that the measuring drone is held in a predefinable attitude by means of an attitude adjustment. This is understood to mean, in particular, the direction in which the measuring drone is aligned, i.e., the horizontal direction in which the measuring drone is pointing. An attitude adjustment can also relate to the attitude of the measuring drone in a plane, i.e., whether the measuring drone tilts in relation to a plane and, if so, in which direction and to what extent.

Control parameters or correcting parameters are constantly produced for the position adjustment or the attitude adjustment, such as, for example, the thrust of a propeller of the measuring drone and the alignment of the propeller or the measuring drone. The wind speed and wind direction and, if necessary, other wind values can be inferred from these control parameters or correcting parameters. The at least one measured value to be recorded is preferably derived in this way.

If, for example, the position of the measuring drone is therefore controlled in its position in such a way that it maintains an inclined position and corresponding thrust power of its propellers in its predefinable position against the wind, the wind direction can be determined from the direction of the inclined position. The wind strength or wind speed can furthermore be determined from the degree of the inclined position and the set thrust power. If necessary, accuracy can be improved by also taking account of further values, such as air temperature, precipitation type, precipitation quantity, relative humidity and/or air pressure. However, this is explained only as an illustrative example and other possibilities are conceivable, such as, for example, the use of a measuring drone in which, instead of or in addition to an inclined position of the measuring drone, the one or more propellers are set to an inclined position and these data allow the wind speed and wind direction to be inferred. In particular, a wind value determined in this way, which can also be referred to as a measured wind value, can similarly be taken into account in determining the measured sound value. In particular, sound pressure levels at a specific location relative to the wind power installation are in fact also dependent on the prevailing wind values.

A measured value can thus be derived from the position adjustment and, furthermore or alternatively, from the attitude adjustment of the at least one drone.

According to one embodiment, the measuring drone, in particular as a measuring means, has at least one measuring sensor to record a wind value in order to record the wind values or some of the wind values by means of this at least one measuring sensor. According to a further embodiment, the measuring sensor or at least one of the measuring sensors is a microphone. Since the operation of the measuring drone can also influence a measuring means of this type, this operation of the measuring drone can be taken into account, if necessary, during the recording of the at least one wind value by the measuring sensor in order to eliminate any distortions.

If the measuring sensor or at least one of the measuring sensors is configured as a microphone, i.e., as a sound sensor, it is attached with a cable or a spacer from a main body of the drone on which the propeller is arranged, and is thus arranged at a distance from the propellers. As a result, the amplitude of the sound striking the microphone is reduced by the propellers.

According to one further embodiment, a sound-reflecting plate is arranged on the cable or on the spacer between the measuring sensor, i.e., in particular at least one microphone, and the main body. As a result, the sound of the propellers is further reduced on the measuring sensor.

At least two measuring drones are preferably used to record the measured values, said measuring drones alternating with one another in order to record the measured values without interruption. This may be considered, in particular, for the use of measuring drones in battery mode. As a result, in the simplest case, one measuring drone can be in the air recording the measured values while the other measuring drone is being charged at a charging point.

A plurality of measuring drones are preferably in use simultaneously, recording the wind values in different predefinable positions. It is conceivable here, in particular, for a plurality of measuring drones to be arranged at a distance above one another in order to be able to record measured values at different heights. In particular, a height profile of the wind or of the sound can thereby be recorded.

A wind characteristic is preferably captured, which may include the capture of a wind shear, i.e., the capture of the change in the wind speed depending on the height. This may also include the capture of a wind veer, i.e., a change in the wind direction depending on the height. Furthermore or alternatively, a wind field can also be captured. Not only a change in the wind values with height, but also in a horizontal direction is therefore evaluated for this purpose. In particular, a wind field of this type can be recorded for the rotor field or an area in front of it. In particular, a dedicated measurement of the wind conditions relevant to the wind power installation concerned is possible as a result.

The position adjustment of the measuring drone is preferably performed by means of a measuring system evaluating GPS data. The position of the measuring drone can thus be recorded via the GPS data and a position adjustment of the measuring drone can be performed as a result. Furthermore or additionally, a change in the position of the measuring drone can be recorded and taken into account. Furthermore or as a supplement, a measuring system evaluating GPS data can be used which is supplemented by one or more stationary reference receivers. Accuracy can sometimes be substantially improved and this system can be configured or can operate as a differential GPS. This system is generally known as a Differential Global Positioning System (DGPS).

Furthermore or alternatively, a system can be used which records or provides position data by means of ultrasonic measurements, i.e., a measuring system evaluating ultrasonic measurements. The use of a measuring system which evaluates radar measurements can also be considered for this purpose. It should be noted that measuring systems evaluating ultrasonic measurements of this type and also measuring systems evaluating radar measurements may essentially be complex and expensive, but the costs can be limited due to the fact that these measuring systems have to be configured only for the targeted position recording of the at least one measuring drone. This affects, in particular, the range and direction spectrum of the system.

The recording of a wind field, a sound field at least one height profile can, alternatively or as a supplement to the use of a plurality of measuring drones, also be performed if the measuring drones or at least one measuring drone changes its position. In other words, a measuring drone can fly here through the wind field, the sound field or a part thereof and can thereby measure the wind field, the sound field or the corresponding part.

The method is preferably characterized in that further weather information is recorded by the at least one measuring drone or in some other way. The measurement quality, in particular, can be improved as a result. On the one hand, the recording of the sound values or wind values, in particular the wind speed, can depend on further weather information, i.e., particularly if the wind speed is derived from control parameters or correcting parameters of a position adjustment. It is furthermore or alternatively conceivable to allocate further weather information to the wind values or to use said weather information as wind values in order to improve the database of recorded wind values. Additionally captured weather information of this type can then, where appropriate, improve an adjustment or control of the wind power installation dependent on thereon.

Further weather information of this type may be air temperature, precipitation type, precipitation quantity, relative humidity, air density and/or air pressure.

A plurality of measuring drones are preferably held at different heights in relation to one another in each case by means of a position adjustment and each of the measuring drones records measured values at its height. This collective position adjustment of the plurality of measuring drones is performed, in particular, in such a way that these plurality of measuring drones together form a virtual measuring mast. These measuring drones then capture measured values at different heights, said measured values otherwise being recorded by a measuring mast. Since these measuring drones are not mechanically fixed, but are positioned in relation to one another only by means of a matched or coordinated position adjustment, they can form a virtual measuring mast or can be regarded as such. An evaluation can preferably be carried out here in the customary manner known for a measuring mast without a measuring mast having to be set up.

This at least one measuring drone, in particular the virtual measuring mast, is preferably positioned depending on a wind direction, in particular upwind of the wind power installation. The at least one measuring drone or the virtual measuring mast preferably tracks the wind direction here if the wind direction changes, particularly in such a way that this at least one measuring drone or the virtual measuring mast is kept essentially upwind of the wind power installation. In particular, an evaluation of the sound profile or the wind profile in front of the wind power installation, or of the sound field or the wind field in front of the wind power installation can thereby be carried out despite changing wind directions. A corrective calculation which may be required in the case of a wind mast which cannot track the wind is not necessary here.

A method for operating at least one wind power installation is also proposed according to the invention. The wind power installation is operated here depending on at least one measured value. For this purpose, it is proposed that the at least one measured value is recorded by at least one measuring drone. The recording is preferably performed as described according to one of the preceding embodiments of the method for recording at least one measured value by means of a measuring drone.

In particular, it is conceivable for the corresponding measured values to be transmitted directly or indirectly from the at least one measuring drone to the wind power installation.

A measuring drone for recording at least one sound value or wind value, in particular a wind speed and/or wind direction, is also proposed according to the invention. A measuring drone of this type comprises a flight control device which is prepared in such a way that the measuring drone flies into a predefinable position and is held there in the predefinable position. The flight control device therefore then performs a position adjustment. Furthermore or alternatively, as soon as the measuring drone has more or less reached its predefinable position, a change in the position of the measuring drone in relation to the predefinable position can also be recorded.

The flight control device can comprise, in particular, a position recording and position deviation, particularly in three coordinate directions. Adjustment errors can then be determined for all three position directions, for example through corresponding target-actual value comparisons, and can be input into an adjustment algorithm which determines corresponding target thrust values therefrom for the respective directions. Such a target thrust value in a vertical direction is relevant here primarily to counteract the dead weight of the measuring drone. The other two target thrust values of different, in particular Cartesian, directions in the horizontal plane can, however, provide an indication of the wind direction and strength, particularly if a stationary accuracy for the position adjustment is finally, at least briefly, achieved.

The target thrust in the vertical direction can be implemented, in particular, via a thrust strength of the propellers, in particular via their rotational speed. The two remaining target thrusts in the directions in the horizontal plane can be achieved, for example, through corresponding inclined positions of the propellers of the measuring drone, or an inclined position of the measuring drone, to name but two examples.

According to one embodiment, the drone determines not only its position in the three spatial directions, but also or alternatively its inclination in the sense of a rotation through these directions. It has been recognized that this inclination is a measure which correlates with the wind direction and wind strength if the vertical position and the horizontal position are maintained simultaneously. For this purpose, it is proposed that this inclination is recorded and the wind direction and, furthermore or alternatively, the wind speed is/are derived therefrom while the horizontal position is maintained.

The flight control device can furthermore or alternatively record the change in the position of the measuring drone in relation to the predefinable position. Insofar as a position adjustment is activated, such changes should be present in any case as adjustment errors and can be evaluated. However, even if an adjustment of this type is not activated, such adjustment errors can nevertheless be recorded as deviations without necessarily changing the position of the measuring drone depending thereon.

The measuring drone furthermore comprises a wind-recording means which can also be referred to as a measured wind value recording means, for recording at least one wind value. This can be done by evaluating the parameters which the flight control device captures and uses, in particular, for the position adjustment. Furthermore or alternatively, however, at least one measuring sensor can also be present on the measuring drone. Alternatively or additionally, the measuring drone comprises a microphone to record a measured sound value.

According to one embodiment, a transmission means is furthermore provided to transmit the at least one recorded measured value to an evaluation device. Instead of or in addition to the measured value, values representing the measured values can also be transmitted, such as, for example, raw data which have been recorded by the measuring drone. The transmission can be performed via a cable connection or via a radio link. Particularly if a variant is chosen in which the measuring drone is supplied with electric current by means of a trailing cable, this trailing cable can additionally be used for data transmission also, for example similar to a d-network. If the measuring drone flies freely with an electric battery, a radiocommunication transmission is conceivable. Insofar as measured values are recorded offline for the final configuration of a wind power installation or wind power installation controller, it is also conceivable to first capture and store recorded values and then transmit them when the measuring drone has landed. This applies particularly if the measuring drone lands near or on the evaluation device and is connected there, for example to charge its battery also.

The measuring drone preferably has one or more electrically driven propellers with an essentially vertical axis of rotation. The flight control device can then be prepared in order to control at least one actuator. An actuator of this type may be the one or more propellers by means of which, in particular, a corresponding drive motor of each propeller can be controlled. An actuator in this sense can also be an adjustment means to adjust the alignment of the vertical axis of rotation of each propeller, insofar as the measuring drone that is used has adjustable axes of rotation of this type. A slight adjustment of this vertical axis of rotation, i.e., for example, through 5 to 10 degrees, to name but one example, can produce a corresponding forward thrust of the measuring drone in the tilting direction of this axis of rotation. In such a slight inclined position, the upward thrust hardly changes, but can be adjusted if required through corresponding control of the propeller or a motor.

An actuator can furthermore be an attitude control means to control an attitude of the measuring drone. This can include aerodynamic elements such as baffle plates. An actuator can also be a direction control means to control a flight direction of the measuring drone. In other words, a configuration similar to that of a helicopter is conceivable here, such as, for example, a tail rotor. However, it is also conceivable for the measuring drone to be equipped as a quadcopter, controlled entirely via the control of the correspondingly provided four propellers.

Is preferably proposed that the measuring drone has an electric battery for its electrical supply in order to store required electrical energy therein. This concerns, in particular, the electrical energy required for flying. However, a computer can also be controlled from the battery, including for recording the measured values.

Alternatively, it is proposed that the measuring drone has a trailing cable for the electrical energy feed. Through the use of a measuring drone of this type for measuring a wind profile or wind field for a wind power installation, the operating range of the measuring drone is very clearly defined and therefore the maximum cable length also, and therefore the weight of this cable to be included in the calculation is well known. The measuring drone can therefore be designed so that it can also lift a corresponding trailing cable. This configuration offers the advantage that a measuring drone can be operated continuously.

According to one embodiment, the measuring drone is characterized by one or more propellers driven by at least one internal combustion engine with an essentially vertical axis of rotation, wherein the flight control device is prepared in order to control at least one actuator. The one or more propellers, an adjustment means to adjust the alignment of the vertical axis of rotation of each propeller, an attitude control means to control an attitude of the measuring drone and a direction control means to control a flight direction of the measuring drone can also be here used as actuators. Explanations of the actuator that have been provided in connection with the one or more electrically driven propellers also apply here accordingly to the embodiment with one or more internal combustion engines.

It is therefore also conceivable for the measuring drone to be driven by one or more internal combustion engines, i.e., for it to have one or more propellers which are driven by one or more internal combustion engines. It can similarly operate autonomously as a result. It can essentially have any functionality which has been or will be described above or below in connection with an electrically drivable measuring drone also. The descriptions above and below relating to an electrically drivable measuring drone, particularly insofar as it has an electric battery, also apply accordingly to the measuring drone which is driven by one or more internal combustion engines.

In particular, it can be provided for a variant which uses a plurality of measuring drones with at least one internal combustion engine that two or more measuring drones alternate with one another in such a way that at least one measuring drone flies and captures measured values while at least one other measuring drone is refueled in a base station. For this purpose, the same variants are proposed accordingly which have been or will be explained above or below for the use of battery-powered measuring drones also. A base station can be provided here also on the ground or on the nacelle of a wind power installation.

One particular advantage of the use of at least one internal combustion engine is that the measuring drone, and also the method for recording at least one measured value, are particularly suitable for remote areas, particularly if the one or more wind power installations are not yet connected to an electrical supply network.

In each case, it is proposed that the measuring drone controls and, if necessary, maintains, its position essentially autonomously. If necessary, a user, such as service personnel, can define a new position. However, it is essentially not provided that a person is permanently tasked with controlling the measuring drone, but the measuring drone is instead intended to fly autonomously and autonomously maintain its position or, if necessary, the position path, in particular by means of the explained position adjustment.

The measuring drone is preferably characterized in that it is prepared in order to be used in a method according to at least one of the embodiments described above. The measuring drone is therefore prepared in order to behave as described in connection with at least one of the embodiments of the method for recording at least one measured value described above.

A measuring arrangement for recording at least one measured value by means of a plurality of measuring drones is furthermore proposed according to the invention. A measuring arrangement of this type comprises a plurality of measuring drones according to one of the embodiments described above. This measuring arrangement furthermore comprises a base station. This base station can be provided to supply the measuring drone with electrical energy. To do this, trailing cables of the measuring drone can be connected to the base station if the measuring drones operate via a cable connection. Alternatively, the base station can achieve the supply by operating as a charging point for the measuring drones or by controlling a charging point of this type.

Furthermore or alternatively, the base station can form the evaluation device and can serve to capture the recorded measured values. This can be done via the trailing cables or via a radio link, or offline if the measuring drones control the base station.

Furthermore or alternatively, the base station can perform the coordination of the measuring drones with one another. This can include defining different positions for the measuring drones which differ, in particular, in terms of their height. Also in the case where the measuring drones are battery-powered and have to control a charging point, i.e., particularly on the base station, alternately, this alternation can be coordinated by the base station.

In particular, the measuring arrangement as a whole can form a virtual measuring mast, wherein the base station evaluates the recorded data and the plurality of measuring drones capture the measured values, i.e., wind values, in the manner of a plurality of vertically distributed measuring sensors.

The base station can be configured as a vehicle, in particular a service vehicle. Alternatively, a wind power installation can also form the base station.

According to the invention, a wind power installation is proposed with a nacelle and a rotor with one or more rotor blades for generating electric power from wind. A wind power installation of this type can be controlled depending on at least one measured value. It furthermore has a data transmission means which is configured to receive measured values from at least one measuring drone. This may also or alternatively concern values representing measured values. For example, the wind power installation can have a radio receiver for this purpose, so that the at least one measuring drone can transmit the measured values via a radio link to the wind power installation However, it is also conceivable for the wind power installation to be connected to the one or more measuring drones via a trailing cable if the measuring drones are of the type having a trailing cable. The data transmission can then be implemented via said cable and the wind power installation can furthermore supply the at least one measuring drone with electrical energy via said cable. It is of course also conceivable for the measuring drones, as generally applies, to transmit the measured values via a radio link despite the use of a trailing cable.

The wind power installation is preferably characterized in that the data transmission means is configured to receive the measured values or the values representing said measured values from a measuring drone according to an embodiment described above. The advantageous characteristics of a measuring drone described above can therefore be used to supply a wind power installation with corresponding wind values.

A wind power installation together with a plurality of measuring drones can advantageously also form a virtual measuring mast. To do this, the measuring drones are coupled to the wind power installation so that the measuring drones capture the measured values for different positions, in particular different height positions, and transmit them to the wind power installation for further processing.

The wind power installation preferably has a charging point for the electric charging of at least one measuring drone. The charging point is preferably arranged on the nacelle of the wind power installation. As a result, depending on the design of the wind power installation, comparatively short flight distances can be achieved between the charging point and the respective positions into which the measuring drone is to fly.

According to one embodiment, the drone is charged with a permanently installed battery. However, it is preferably proposed to provide a plurality of batteries for exchange and to remove the spent battery from the drone in order to replace it with a freshly charged battery. This offers the advantage that the charging time of a single battery can be longer than the flight time of the drone and nevertheless only two drones, but a plurality of batteries, are required.

A wind power system for generating electric power from wind is furthermore proposed, comprising at least one wind power installation according to an embodiment described above and furthermore having at least one, preferably a plurality of, measuring drones, as described according to at least one embodiment described above. According to one embodiment, the wind power system is configured as a windfarm with a plurality of wind power installations. Furthermore or alternatively, it can be provided to use a plurality of measuring drones, in particular a measuring arrangement with a plurality of measuring drones, as described above according to at least one corresponding embodiment. A virtual measuring mast described above is preferably used.

### BRIEF DESCRIPTION OF THE SEVERAL VIEWS OF THE DRAWINGS

The invention will now be explained in detail below by way of example on the basis of embodiments with reference to the accompanying figures.

FIG. 1 shows a wind power installation in a perspective representation.

FIG. 2 shows a windfarm in a schematic representation.

FIG. 3 shows an example of a control diagram to carry out a method according to the invention.

FIGS. 4-7 show different configurations of a wind power system with a wind power installation and a plurality of measuring drones.

FIG. 8 shows a measuring drone with a microphone.

### DETAILED DESCRIPTION

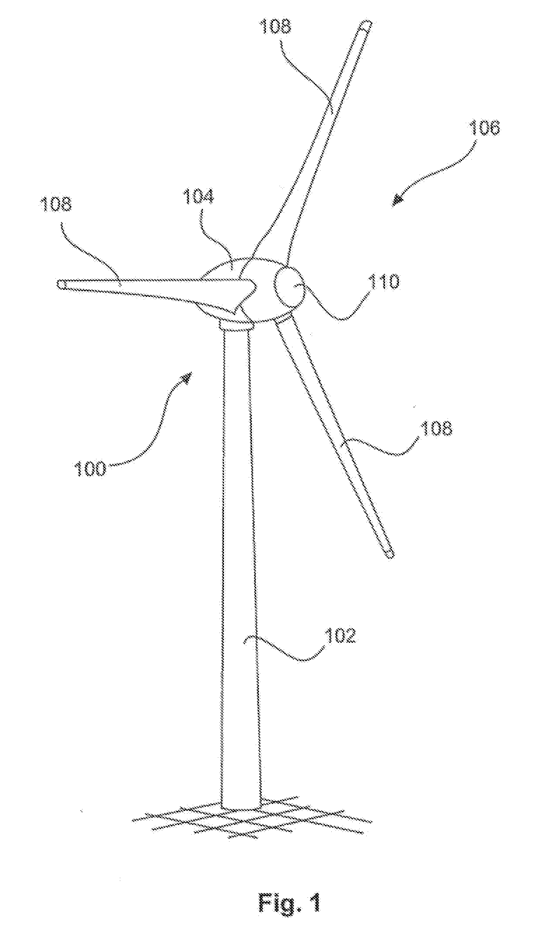

FIG. 1 shows a wind power installation 100 with a tower 102 and a nacelle 104. A rotor 106 with three rotor blades 108 and a spinner 110 is arranged on the nacelle 104. The rotor 106 is set in rotational motion by the wind during operation and thereby drives a generator in the nacelle 104.

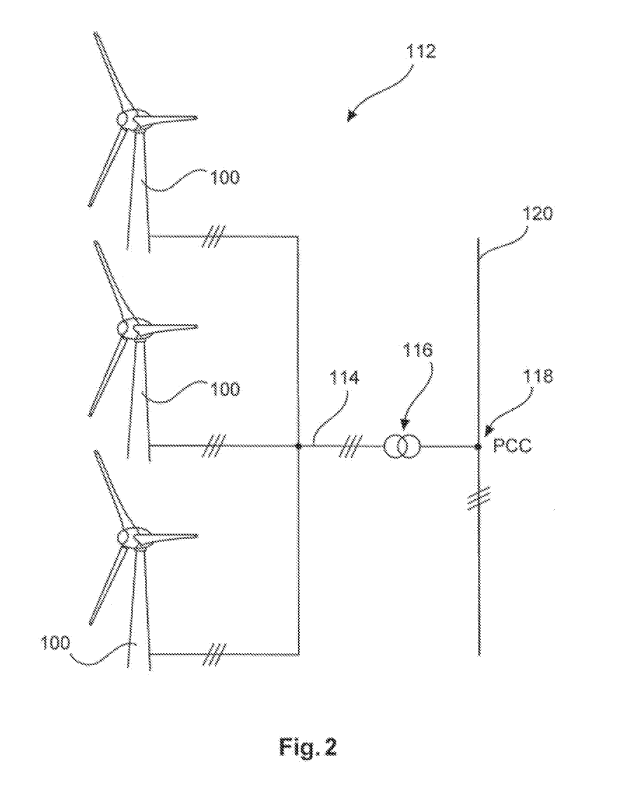

FIG. 2 shows a windfarm 112 with, by way of example, three wind power installations 100, which may be identical or different. The three wind power installations 100 thus represent essentially any number of wind power installations of a windfarm 112. The wind power installations 100 provide their power, i.e., in particular, the generated current, via an electric windfarm grid 114. The currents or powers of the individual wind power installations 100 generated in each case are added together and a transformer 116 is usually provided to step up the voltage in the windfarm and then feed it at the feed-in point 118, which is also generally referred to as the PCC, into the supply grid 120. FIG. 2 is only a simplified representation of a windfarm 112, which, for example, shows no control, although a control is obviously present. The windfarm grid 114 may, for example, also be designed differently in that, for example, a transformer is also present at the output of each wind power installation 100, to name but one different example embodiment.

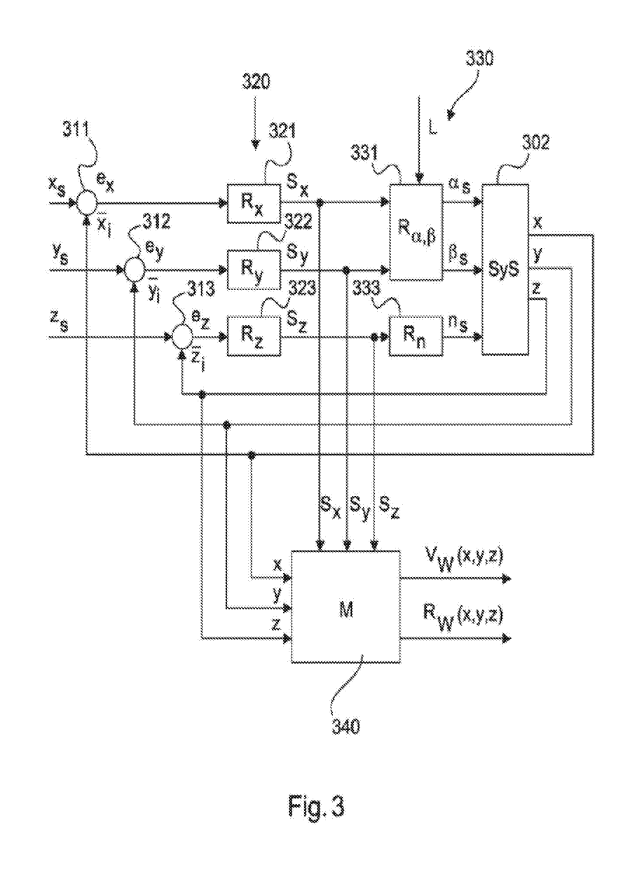

FIG. 3 shows a simplified adjustment structure of one embodiment for a position control of a measuring drone, including evaluation of control values of the adjustment for recording measured values, such as wind speed and wind direction. The measuring drone is contained therein as a system 302. During flight operation, the measuring drone 302 is more or less randomly positionable in space and its position is indicated here by the coordinates x, y and z. Here, for example, the coordinate x can indicate a position in the north-south direction, the coordinate y can indicate a position in the east-west direction and the coordinate z can indicate a vertical direction and therefore the height of the measuring drone 302. These three coordinates x, y and z accordingly form the output parameters of the system for the position adjustment.

A predefined position can be predefined by the corresponding target values xₛ, yₛ and zₛ. A target-actual value comparison is now carried out for each of the coordinates x, y and z on the summing elements 311, 312 and 313, wherein the actual values xᵢ, yᵢ, and zᵢ are incorporated with negative signs.

In each case, this then produces an adjustment error, i.e., eₓ, e_{y} and e_{z}. The adjustment errors are then incorporated into the first subcontroller 320. The first subcontroller 320 has an individual thrust controller for each coordinate, i.e., an X thrust controller 321, a Y thrust controller 322 and a Z thrust controller 323. Each of these three thrust controllers of the first subcontroller 320 outputs a thrust which is to be set, i.e., a thrust power which is to be set, in the corresponding coordinate direction, i.e., the thrusts or thrust powers Sₓ, S_{y} and S_{z}. The index in each case indicates the relevant direction. These three thrusts Sₓ, S_{y} and S_{z} can therefore be referred to as control parameters or correcting parameters. The term “control parameter” is to be preferred here as no direct physical control of an actuator is yet involved, as will become clear below. In this example of a system, as shown in FIG. 3, the implementation is based on a measuring drone 302 which is controlled by controlling its propellers in terms of the rotational speed n and in terms of a tilting of the axis of rotation of the propellers in two tilting directions, i.e., the tilting directions α and β.

In order to adjust the vertical position z of the measuring drone 302, it can be assumed in simple terms that this can be achieved via a setting of the rotational speed n. A rotational speed controller 333 is provided accordingly. This controller receives the target vertical thrust S_{z} as input and calculates a target rotational speed nₛ therefrom.

For the position adjustment in the x direction and y direction, a setting of the vertical axis of the propellers in terms of the two tilting angles α and β is available as a final control element, wherein these two tilting angles α and β can be adjusted in directions at right angles to one another. These two tilting angles α and β should be adjusted together, particularly if the alignment of the measuring drone 302 can vary in relation to the x direction and y direction. The multi-parameter controller 331 is therefore provided in the structure shown by way of example in FIG. 3. This controller takes account jointly of the two thrusts Sₓ and S_{y} in the x and y direction respectively and outputs target values for the two tilting angles α and β, i.e., the target angles αₛ and βₛ., as a joint result. In the case of an exact alignment of the measuring drone 302, for example in the north-south direction, if the tilting angle α then relates precisely to the north-south direction and the tilting angle β relates precisely to the east-west direction, a separation of this multi-parameter controller 331 into two single controllers would be conceivable, so that the proposed thrust in the x direction Sₓ would therefore directly change only the tilting angle α and the thrust in the y direction S_{y} would directly affect only the tilting angle β. However, since this precondition is not normally met, a corresponding conversion into the multi-parameter controller 331 can take place or be taken into account by considering the alignment of the measuring drone 302, which is denoted here as the attitude L. This attitude L is input into the multiparameter controller 331 for this purpose.

The multiparameter controller 331 together with the rotational speed controller 333 thus forms a second subcontroller 330.

In any case, the results of this simplified and clear structure shown in FIG. 3 of the multiparameter controller 331 and the rotational speed controller 333 are the target values αₛ and βₛ for two tilting angles of the propellers and the target rotational speed nₛ for the rotational speed of the propellers. These three target parameters are input accordingly into the system 302 and are therefore transferred to the measuring drone 302 for implementation, or they are transferred to the corresponding final control elements for adjustment of the propeller axes and the motors for setting the rotational speed. These final control elements themselves can of course in each case also have an adjustment structure as an inner control cascade.

In the idealized case where the measuring drone 302 is located exactly and immovably in its predefined position, i.e., as predefined by the target coordinates xₛ, yₛ and zₛ, a stationary accuracy would be provided for this position adjustment and the adjustment errors eₓ, e_{y} and e_{z} would therefore be 0. In this situation, the wind speed V_{w} and wind direction R_{w} can be derived from the thrusts of the three coordinate directions, i.e., Sₓ, S_{y} and S_{z}. It is of course assumed here, unless there is no wind, that these thrusts Sₓ, S_{y} and S_{z} have non-zero values. The first subcontroller 320 accordingly has an integral component in each of its blocks. Thus, the x thrust controller 321, the y thrust controller 322 and the z thrust controller 323 in each case have an integral or integrally acting component. The measurement recording block or controller 340 receives the three thrust values Sₓ, S_{y} and S_{z} in order to calculate the wind speed V_{w} and wind direction R_{w}. In order to allocate the wind values calculated therefrom, i.e., the wind speed V_{w} and the wind direction L_{w} to the respective coordinates in which they were recorded, these coordinates x, y and z are similarly input into the measurement recording block 340. The wind values can be allocated accordingly to these coordinates x, y and z. The measurement recording block 340 outputs the wind speed V_{w} (x, y, z) and the wind direction R_{w} (x, y, z) accordingly. These wind values can then be further processed and can also be used, taking account of the coordinates allocated to them, in order to record a wind field. To record a wind profile, it may suffice here to take account of the vertical coordinates z only. If the wind field is to be recorded, particularly for the entire rotor plane, the coordinates x and y are also required, wherein the coordinates x and y can be converted into a representation with only one varying horizontal coordinate.

The air density, for example, can be inferred from the vertical thrust S_{z}, this being proposed as one aspect.

Additionally or alternatively to this adjustment according to the simplified adjustment structure shown in FIG. 3, at least the wind speed and wind direction can be derived from the inclination of the measuring drone. If drive rotors are immovably connected to the measuring drone, the rotational speed of each individual rotor and therefore its thrust are adjusted so that the desired inclination and movement direction are set. As a secondary condition, the requirement can be incorporated that the sum of the individual rotor thrusts to maintain the vertical position corresponds exactly to the flight weight or causes a desired upward or downward acceleration.

For the implementation, the software that is used can output position data and the angle of inclination. These data can be stored and transmitted telemetrically to a ground station. The evaluation can be carried out, for example, at the ground station.

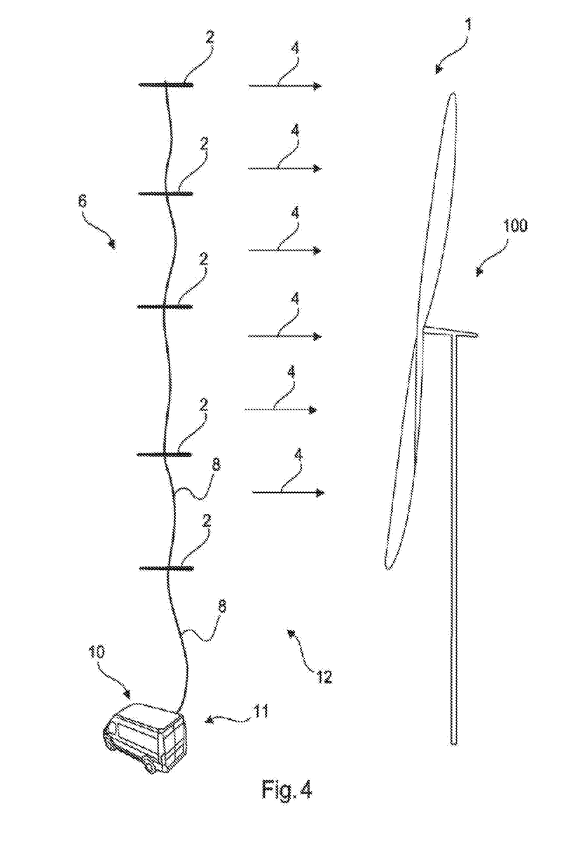

FIG. 4 shows schematically a wind power system 1 with a wind power installation 100 and a plurality of measuring drones 2. In this schematic representation shown in FIG. 4, the measuring drones 2 are arranged, in relation to the schematically indicated wind 4 which is characterized by corresponding arrows, in front of the wind power installation 100, i.e., upwind of the wind power installation 100. The measuring drones 2 are arranged essentially vertically above one another and thus form a virtual measuring mast 6. According to this variant shown in FIG. 4, a supply cable 8 is provided via which the measuring drones 2 are supplied with electrical energy. The measuring drones share a common supply cable 8, which can also be referred to as a trailing cable. Through the use of this common supply cable 8, the total weight that has to be borne by the measuring drones 2, additionally due to the supply cable 8, is minimized overall. The supply is implemented here via a base station 10 which is configured here as a service vehicle. The measuring drones 2 with the supply cable 8 and the base station 10 thus also form a measuring arrangement 12 for recording at least one measured value by means of the measuring drones 2.

According to this embodiment, a measurement of measured values in a desired position in relation to the wind power installation 100 can thus be achieved in a simple manner. In particular, it is thus possible to capture not only individual measured values, but also a wind profile or a wind field or, in the case where a microphone is provided, sound profiles or sound fields, in a simple manner, always upwind of the wind power installation 100. This is essentially possible for any prevailing wind direction, since the measuring drones 2 simply have to be guided into the corresponding position upwind of the wind power installation. Said measuring drones can also track the wind in a simple manner so that a measurement can be carried out upwind even after a change in the wind direction. If necessary, the base station 10 which is configured here as a service vehicle and, in particular, provides the electrical supply of the measuring drones 2 can similarly change its position if the wind direction has changed. Alternatively, it can also be provided that the corresponding section of the supply cable 8, particularly the section between the base station 10 and the lowermost measuring drone 2, is so long that the position of the base station 10 does not have to be changed, or at least does not have to be changed in the event of slight changes in the wind direction.

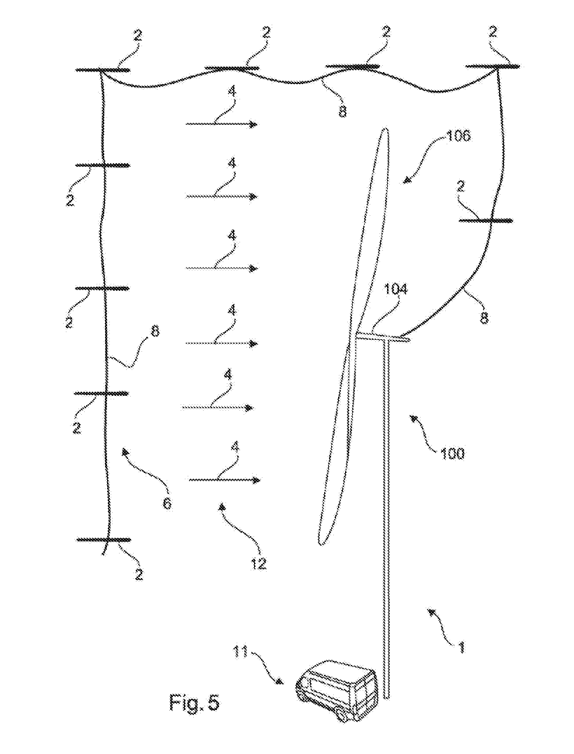

FIG. 5 shows a design in which a plurality of measuring drones 2 are similarly supplied via a supply cable 8. The supply is implemented here via the wind power installation 100, wherein the supply cable 8 is connected to the nacelle 104 or is connected to a corresponding supply unit in the vicinity of the nacelle 104.

Here also, various measuring drones 2 are arranged in front of the wind power installation 100 in relation to the wind 4. It is essentially also conceivable to carry out a measurement that is not upwind of the wind power installation, if this is required.

In any case, a virtual measuring mast 6 which records measured values and, in particular, can also record a height profile of the wind 4 can also be formed in a simple manner with measuring drones 2 according to this embodiment shown in FIG. 5. Further measuring drones 2 which route the supply cable from the nacelle 104 via the rotor 106 to the desired position in which the measurement is intended to be carried out, i.e., in this example upwind of the wind power installation 100, are provided for a cable routing of the supply cable 8. The terms “supply cable” and “trailing cable” can be used synonymously here.

Captured data, in particular measured values or values corresponding thereto, can be transmitted to the wind power installation 100 or, furthermore or alternatively, to the service vehicle 11. A coordination of the measuring drones 2 and particularly the virtual measuring mast 6 also can also be performed by the service vehicle 11. A subtask of a base station, i.e., the energy supply, can be performed here by the wind power installation 100, in particular by a corresponding device in the nacelle 104.

It should be noted that, in this detailed description of the figures, particularly in the description of FIGS. 4 to 7, the same reference numbers are used for similar, possibly not identical, elements. The service vehicle 11 may, for example, differ between FIG. 4 and FIG. 5 and further figures since it provides the electrical supply of the measuring drones 2 in one case but not in another. The measuring drones 2 may also be identical in the embodiments of FIGS. 4 to 7, but may also differ. It could be provided, for example, that, according to the embodiment shown in FIG. 5, the measuring drones 2 which are arranged in front of the wind power installation 100 have a different evaluation functionality compared with the measuring drones 2 which are provided essentially only to route the supply cable 8. The measuring drones may possibly also differ in terms of their size. In particular, a measuring drone 2 which does not have to carry a trailing cable may possibly be designed as smaller than those measuring drones 2 which have to carry a cable. However, identical measuring drones 2 are preferably used for each position in order to simplify the operation of the measuring arrangement 12.

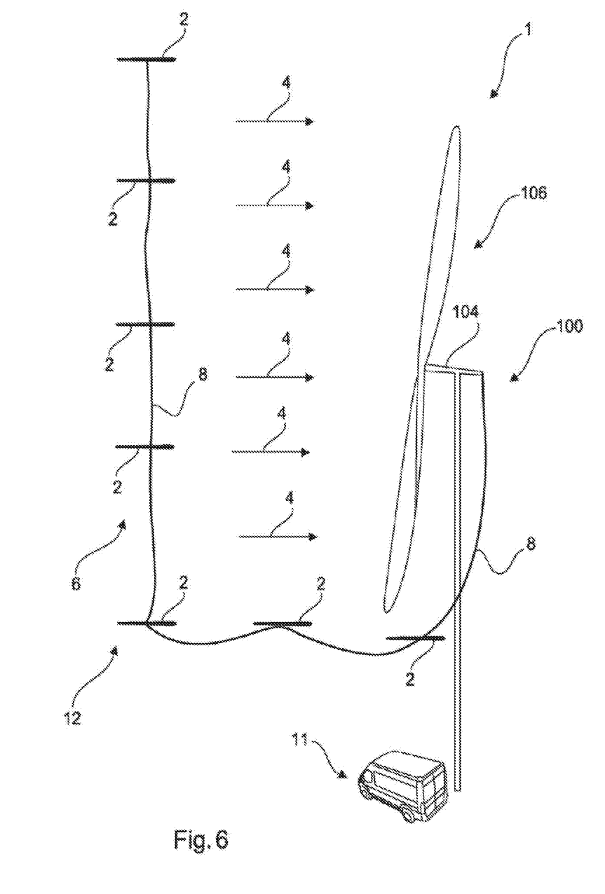

The measuring arrangement 12 shown in FIG. 6 and therefore also the wind power system 1 differ from the measuring arrangement 12 and the wind power system 1 shown in FIG. 5 essentially only insofar as a different routing of the supply cable 8 is provided, i.e., from the nacelle 104 and from the rotor 106 of the wind power installation 100 through to the position of the virtual measuring mast 6 in front of the wind power installation 100. Otherwise, reference is made to the embodiment shown in FIG. 5 for further explanations.

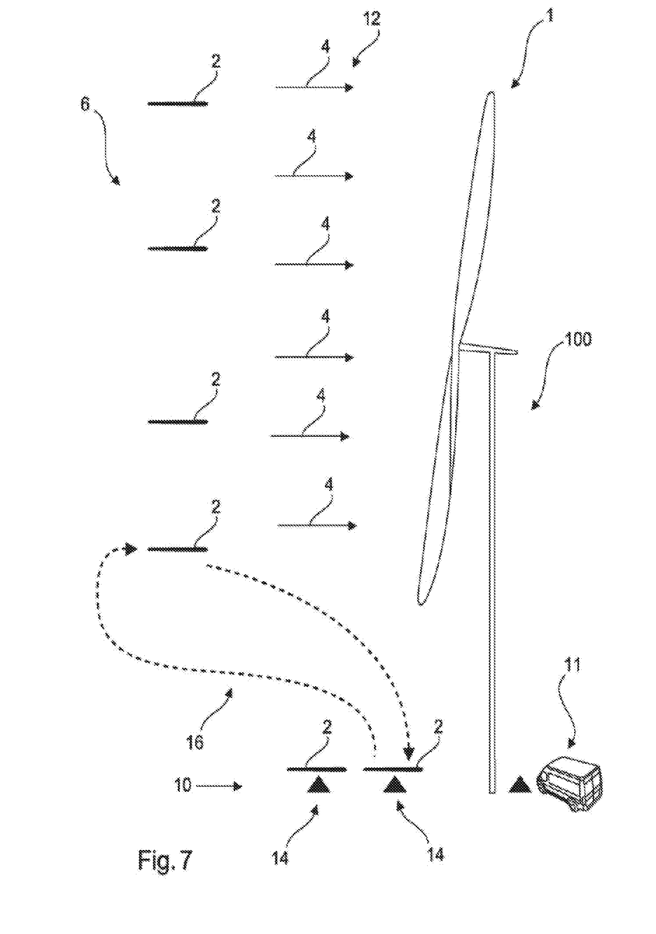

Finally, FIG. 7 shows a wind power system 1 and therefore also a measuring arrangement 12 in which the measuring drones 2 operate without a supply cable. Each measuring drone 2 has a battery or similar electrical energy storage device for this purpose. The measuring drones 2 can be arranged spatially independently from one another. However, the formation of a virtual measuring mast 6 is therefore also possible. A virtual measuring mast 6 of this type is formed here also, i.e., in this example from four measuring drones 2 which are similarly positioned by way of example in front of the wind power installation 100 in relation to the wind 4. These measuring drones 2 shown in FIG. 7 can therefore perform the same tasks as the measuring drones 2 with a supply cable 8 according to the embodiments shown in FIGS. 4 to 6. However, the measuring drones 2 in the embodiments shown in FIGS. 4 to 6 can essentially fly as long as required into their position and can thereby continuously perform measurements and forward the measurement results.

Two charging points 14 are provided instead for the measuring drones 2. One measuring drone 2 can be charged in each case at these charging points 14, i.e., two measuring drones 2 in total. If at least one measuring drone 2 is charged, an exchange procedure 16 can be carried out in which a charged measuring drone 2 leaves one of the charging points 14 and assumes the position of a measuring drone 2 which can then fly to the charging point 14 and can be charged there. A coordination can be performed here also by the service vehicle 11. The charging points 14, together with the service vehicle 11, can form a base station 10 for the measuring drones 2 and thus for the entire measuring arrangement 12.

According to one variant, the charging stations, wherein, in the simplest case, one charging station could also suffice, are arranged on the nacelle of the wind power installation 100. As a result, it can also be achieved, inter alia, that the charging points are thereby protected against unauthorized access. The measuring drones can then also operate completely autonomously and require no monitoring.

According to one embodiment, a solution can be provided in which the measuring drones have batteries or similar electrical energy storage devices which are exchanged for charging. A line of a plurality of batteries, e.g., five or more batteries, can be charged at an identical number of charging points for this purpose. The battery or batteries, in each case fully charged, is/are made available at the end of the line for docking onto a drone. The spent battery is removed from the drone and is placed on a charging point at the back end of the line and is charged there. Fewer drones are thus required for the same functionality and more time is available for charging, thus lengthening the service life of the batteries. An arrangement of this type can also be provided on the nacelle of the wind power installation.

Wind measurements can be carried out in front of the wind power installation from changing wind directions also. This avoids problems which are known from fixed meteorological masts in that no permanently installed meteorological mast is required, but rather an autonomously flying apparatus with automatic attitude and position adjustment is used at the same distance in the direction of flow in front of the wind power installation. This autonomously flying apparatus is referred to here as a measuring drone.

The flying object, i.e., the measuring drone, is preferably equipped with electrically driven propellers with a vertical axis of rotation which supply the necessary boosts. This measuring drone can be configured according to the principle of a multicopter. According to one embodiment, deviating from the technology of free-flying drones, batteries or accumulators no longer need to be carried as an energy source for the intended use, and the energy supply can be performed instead via a cable connection. However, the flying height is then limited by the weight of a cable of this type, i.e., a supply cable, whereas the flying time can be unlimited here.

Alternatively, battery-powered flying objects, i.e., particularly measuring drones with a battery, can be used. Due to the limited flying time, a cyclical replacement of the flying object with a different, freshly charged object can be implemented. In this case, the replacing object, i.e., the measuring drone, flies from a charging point installed on the ground or on the nacelle, such as the charging point 14, to the position of the object which is to be replaced, while the object which is to be replaced flies back to the charging point. The flying objects described here are also referred to as measuring drones and these terms can be used synonymously in this context. If the charging times are greater than the flying times, it is proposed to arrange correspondingly more charging points and objects per object position in order to maintain temporally continuous operation as far as possible.

Conventional systems, such as, for example, gyros, including electronic gyros, and optical systems or combinations thereof are proposed for the attitude adjustment.

The position adjustment is intended to hold the object rigidly at a predefined position and height, wherein the position can still be changed. GPS-based systems and possibly ultrasonic devices and radar devices are used for this purpose and for height measurement. The accuracy of GPS-based systems can be substantially improved through the use of stationary reference receivers on or near the wind power installation. This is also known as “Differential GPS”.

Since the wind direction and the wind speed are the primarily required measurement parameters, the control parameters calculated by the flight controller to maintain the position can be used directly as a measurement signal. Alternatively or additionally, the flying object could also carry conventional measuring sensors.

It is proposed, in particular, to station a plurality of these objects, i.e., these flying objects, at a geometric position, but at different heights, thus forming a virtual meteorological mast, i.e., in particular a virtual meteorological mast 6 shown in FIGS. 4 to 7.

If the wind power installation tracks the wind, i.e., if the wind changes its direction, such a column of flying objects which can form the aforementioned virtual meteorological mast can be transferred into a correspondingly new position, in particular into the then new position upwind of the wind power installation.

The disadvantage here with a tracking of this type could be the cable-connected energy supply, which would similarly have to track the wind. This can be avoided by means of a preferred embodiment of the invention in which the energy supply of the flying objects, i.e., the measuring drones 2, is provided from the nacelle. FIGS. 5 and 6 show a variant of this type in which the cables are routed around the rotor. This can be done, for example, above or below the rotor, i.e., below the rotor diameter or below the rotor surface.

A cyclical replacement of battery-powered flying objects, i.e., battery-powered measuring drones, avoids the disadvantages of the cable operation as a whole, but may require a greater number of flying objects and additional charging points with correspondingly higher costs. A cyclical replacement of this type is described by way of example in FIG. 7.

The invention has been described particularly for measurement for the use of wind power installations. However, other measuring tasks in the atmosphere which involve flows in the range from 0 to 300 meters above ground level and which must invariably be stationary can thereby be performed if necessary.

However, it is provided, in particular, to use the invention as a replacement for stationary meteorological masts.

It is thus particularly proposed to provide an arrangement of flying platforms, i.e., flying objects or measuring drones, at fixed positions, i.e., particularly predefinable positions, for measuring purposes. It is advantageous to combine a plurality of such platforms to form virtual meteorological masts. An unlimited flying time is at least theoretically achievable by means of a cable-connected energy supply. An energy supply can be provided here from the ground or from a nacelle of a wind power installation. Position adjustment signals or attitude adjustment signals can be used as a measured value. A telemetric wireless data transmission to a central station is particularly preferably implemented. A central station of this type can form part of a described base station. However, the transmitted data can also be evaluated instead or additionally at other locations, such as in a process computer of a wind power installation or in a windfarm controller in a windfarm in a central evaluation unit which does not have to be in the immediate vicinity of the measuring drones or the aforementioned flying platforms. It should be noted that the term “flying platforms” is used here to emphasize that flying platforms of this type are not intended to fly as an end in itself, but rather to perform measuring tasks in particular and thus create a platform for the performance of these measuring tasks.

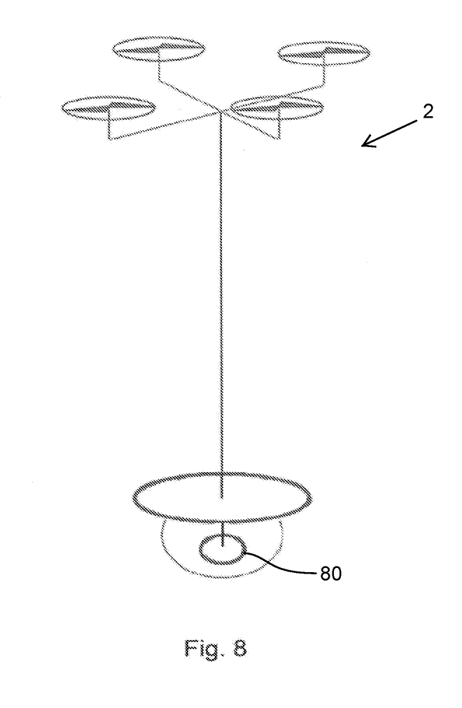

FIG. 8 shows a measuring drone 2 with a microphone 80. The microphone 80 serves to capture measured values, i.e., measured sound values, such as the sound pressure or frequencies of the sound. The microphone 80 is suspended with a cable 82 below the drone 2 on the main body 84 of the drone 2. The part of the drone on which the propellers 85 are arranged is referred to the main body 84 of the drone 2. A sound-reflecting plate 86 which shields the noises of the drone 2 is located on the cable 82 above the microphone 80.

1. A method comprising:
recording at least one measured value, wherein the at least one measured value is recorded by at least one measuring drone, wherein the recording includes:
flying the at least one measuring drone into a predefinable position to record the measured value;
holding the at least on measuring drone in the predefinable position by a position adjustment or its change in relation to the predefinable position is recorded;
recording the at least one measured value; and
storing the at least one recorded measured value or at least one value representing said recorded measured value in a controller.

2. The method as claimed in claim 1, wherein the at least one measured value is a sound value measured by a microphone.

3. The method as claimed in claim 1, wherein the predefinable position is a first predefinable position, the method further comprising flying the at least one measuring drone into a second predefinable position and holding the at least one measuring drone in the second predefinable position by a position adjustment or its change in relation to the second predefinable position, and said measuring drone records at least one further measured value.

4. The method as claimed in claim 1 wherein at least one measured wind value is recorded as a measured value, in particular with a measuring sensor of the drone configured as a measured wind value recording means.

5. The method as claimed in claim 4, wherein at least one value is selected as the at least one measured wind value from the list containing:
a wind speed;
a wind direction; and
a gustiness of the wind.

6. The method as claimed in claim 4, wherein the measuring drone:
is held in the predefinable position by a position adjustment; and/or
is held in a predefinable attitude by an attitude adjustment; and
the at least one wind value is derived from the position adjustment the attitude adjustment or both.

7. The method as claimed in claim 1, wherein at least two measuring drones alternate with one another during the recording of the measured values in order to record the measured values without interruption.

8. The method as claimed in claim 1, wherein a plurality of measuring drones are used simultaneously and record the measured values in different predefinable positions.

9. The method as claimed in wherein the at least one measured value is one of:
at least one wind shear,
at least one wind veer, and
a wind field.

10. The method as claimed in claim 1, wherein the position adjustment of the measuring drone is performed by at least one measuring system, wherein the at least one measuring system is:
a measuring system evaluating GPS data,
a measuring system evaluating GPS data supplemented with one or more stationary reference receivers,
a measuring system evaluating ultrasonic measurements, and
a measuring system evaluating radar measurements.

11. The method as claimed in claim 1 further comprising recording weather information, wherein the weather information is one of:
air temperature,
precipitation type,
precipitation quantity,
relative humidity,
air density, and
air pressure.

12. The method as claimed in claim 1, wherein a plurality of measuring drones are held at different heights in relation to one, wherein each of the measuring drones records measured values at the respective heights to form a virtual measuring mast.

13. The method as claimed in claim 1, wherein the at least one measuring drone is positioned upwind of the wind power installation.

14. A method for operating at least one wind power installation, wherein the wind power installation is operated depending on at least one wind value and the at least one wind value is recorded by at least one measuring drone using the method as claimed in claim 1.

15. A measuring drone for recording at least one measured value, the measuring drone comprising:
a flight control device configured to cause the measuring drone to fly into a predefinable position and hold the flight control device in the predefinable position, wherein a change in the position of the measuring drone in relation to the predefinable position is recorded;
a measuring means configured to record the at least one measured value; and
a transmission means configured to transmit to a controller the at least one recorded measured value or at least one value representing said at least one recorded measured value.

16. The measuring drone as claimed in claim 15, wherein the measuring means is at least one microphone configured to record measured sound values.

17. The measuring drone as claimed in claim 15, wherein the measuring means is connected via a cable or a spacer to a main body.

18. The measuring drone as claimed in claim 17, wherein a plate is arranged on the cable or on the spacer between the measuring means and the main body, wherein the plate is a sound-reflecting plate.

19. The measuring drone as claimed in claim 15, wherein the measuring means comprises at least one measured wind value recording means.

20. The measuring drone as claimed in claim 15, comprising:
one or more electrically driven propellers with an essentially vertical axis of rotation, wherein the flight control device is prepared to control at least one actuator selected from the list containing:
the one or more electrically driven propellers,
an adjustment means to adjust alignment of the vertical axis of rotation of each propeller,
an attitude control means to control an attitude of the measuring drone, and
a direction control means to control a flight direction of the measuring drone.

21. The measuring drone as claimed in claim 15 further comprising:
an electric battery configured to store electrical energy, or
a trailing cable configured to supply electrical energy.

22. The measuring drone as claimed in claim 15, comprising:
one or more propellers driven by at least one internal combustion engine with an essentially vertical axis of rotation, wherein the flight control device is prepared to control at least one actuator selected from the list containing:
the one or more electrically driven propellers,
an adjustment means for adjusting alignment of the vertical axis of rotation of each propeller,
an attitude control means to control an attitude of the measuring drone, and
a direction control means to control a flight direction of the measuring drone.

23. (canceled)

24. A measuring arrangement for recording at least one measured value that is a measured sound value or a measured wind value, by using a plurality of measuring drones, and wherein the arrangement comprises:
a plurality of measuring drones as claimed in claim 15; and
a base station to perform at least one function from the list containing the functions:
supplying the measuring drones with electrical energy,
capturing recorded measured values, and
coordinating the measuring drones with one another.

25. A wind power installation comprising:
a nacelle; and
a rotor with rotor blades for generating electrical power from wind, wherein:
the wind power installation is configured to be controlled depending on at least one measured value; and
has a data transmission means configured to receive measured values or values representing said measured values that have been recorded and transmitted by at least one measuring drone as claimed in claim 15.

26. (canceled)

27. The wind power installation as claimed in claim 25, wherein a charging point is provided for the electrical charging of the at least one measuring drone, wherein the charging point is arranged on the nacelle of the wind power installation.

28. A wind power system for generating electrical power from wind, the wind power system comprising at least one wind power installation as claimed in claim 25.
